(19) United States
(12) Patent Application Publication
(10) Pub. No.: US 2013/0202505 A1
(43) Pub. Date: Aug. 8, 2013

(54) PROCESS FOR TREATING GREENHOUSE GAS

(71) Applicant: King ching Ng, Guangdong (CN)

(72) Inventor: King ching Ng, Guangdong (CN)

(21) Appl. No.: 13/879,018

(22) PCT Filed: Oct. 14, 2011
(86) PCT No.: PCT/CN2011/080814

§ 371 Date: Apr. 11, 2013

(30) Foreign Application Priority Data
Oct. 15, 2010 (CN) 201010508190.X

(51) Int. Cl. B01D 53/75

(52) U.S. Cl. CPC B01D 53/75
USPC 423/210

(57) ABSTRACT

A process for treating a greenhouse gas uses a recovery device (1) to recover the greenhouse gas, and then carries out a treatment by burning the same in a gas burner (2). This process reduces the emission of the greenhouse gas, and can be used in such areas as industry, canteens, power plants, and so on.

### BACKGROUND OF THE INVENTION

The invention relates to a process for treating a greenhouse gas produced by areas such as industry, canteens, power plants, and so on.

At present, in the development of the existing areas such as industry, canteens, power plants, and so on, large amounts of greenhouse gases such as carbon dioxide CO₂, water vapor H₂O, methane CH₄, ethane C₂H₆, and air and the like are produced. The existing modes for treating greenhouse gases include a purification treatment mode and a collection treatment mode. The purification treatment mode also can be divided into a mechanical filtration mode, a wet mode and an electrostatic adsorption mode and the like, such as patent No. 200820055099.5, ‘a filtering device for greenhouse gas emissions’' patent No. 200820039891.3, ‘a purifying machine for greenhouse gases’, and patent application No. 97190177.5, ‘method and device for greenhouse gas transformation’; there are also many collection treatment modes of greenhouse gases: such as container-type collection mode and an underground-type collection mode and the like, such as patent No. 200710048836.9, ‘an emission reduction and commercialized utilization method of greenhouse gases’ and patent No. 200780040798.0, ‘a method for storing isolated greenhouse gas in deep underground reservoir stratums’. The methods above mentioned are all the existing greenhouse gas solutions, but can not completely eradicate the emissions of greenhouse gases. The purification treatment mode of greenhouse gases is mainly used for purifying a small part of harmful gases in greenhouse gases; and the collection treatment mode is mainly used for storing or reusing greenhouse gases, but the utilization rate is not high, and in some modes, only one kind or a part of harmful gases in greenhouse gases are utilized, and most of the rest greenhouse gases are eventually emitted to the atmosphere, therefore, great environmental pollutions are caused, and the greenhouse effect of the earth is difficult to change.

### BRIEF SUMMARY OF THE INVENTION

The purpose of the invention is to provide a brand-new solution for treating greenhouse gases, to solve the problem of the prior techniques that the greenhouse gases are treated incompletely, and most of greenhouse gases are finally emitted to the air, thereby causing the environmental pollution and aggravating the greenhouse effect of the earth.

A process for treating a greenhouse gas is implemented by recovering the greenhouse gas using a recovery device and then carrying out a treatment by burning the same in a gas burner.

The recovery device is a recovery tube arranged at the upper part of an indoor space, the recovery tube is at least equipped with an exhaust fan, and the recovery tube is at least provided with an exhaust port.

The gas burner is provided with a water vapor feeder for feeding water vapor into the gas burner.

The exhaust port is provided with a water vapor feeder.

The recovery tube is provided with a sealed container for storing the greenhouse gas.

The gas burner comprises a safety valve, a furnace body and a siphon preheating gas drum, an expander is arranged in a hearth of the furnace body, the siphon preheating gas drum is a pipeline which is annularly wound around the furnace body and communicated to the inside of the expander, and the furnace body is provided with a blocking plate with a round hole at the central position thereof.

The expander is divided into internal expander and external expander, the internal/external expanders are respectively a cylindrical, square, polygonal or starlike with a cavity, a plurality of through holes are distributed on the side edge of each cavity, and an external expander is sleeved on an internal expander, so that a compression chamber is formed between the internal expander and the external expander.

The number of the internal expander or the external expander is one or more than two, so that one or more compression chambers are formed.

A connecting component is arranged between the internal expander and the external expander.

A gas inlet channel is arranged between the furnace body and the hearth, and plurality of through holes are distributed on the side wall of the hearth.

### BENEFICIAL EFFECTS OF THE INVENTION

1. In the invention, the gas burner is adopted for carrying out burning treatment on recovered greenhouse gases, or carrying out burning treatment on any kind of greenhouse gas or different gas mixtures, and because the burner is provided with the expander and the blocking plate, in the process of burning, the molecular structures of various different elements in greenhouse gases are reduced to the simplest atomic structures, then a complete energy is obtained as a burning improver sufficiently burned, and then decomposed into oxygen-rich gases which are emitted subsequently the complete energy after heat and light emissions under high-temperature burning, so that the problem of the prior techniques that greenhouse gases are treated incompletely, and most of greenhouse gases are finally emitted to the air, thereby polluting the environment and causing the rapid deterioration of the greenhouse effect of the earth is completely solved.

2. Because the gas burner in the invention carries out burning treatment on recovered greenhouse gases, and takes greenhouse gases (carbon dioxide and water vapor) as burning improvers for gas burning, a traditional old belief that water vapor and carbon dioxide can not be directly used for burning improvement is broken, and molecules of carbon dioxide and water vapor are decomposed into hydrogen, carbon and oxygen atoms participating in burning, so that the utilization rate of gases is higher, thereby realizing further energy conservation and achieving a good energy conservation and environment protection effect.

3. Because the exhaust port in the invention is provided with the water vapor feeder, oxygen-containing molecule compositions in water vapor emitted from the water vapor feeder and carbon dioxide in greenhouse gases are richer than those in air, so that the water vapor emitted from the water vapor feeder and the carbon dioxide in greenhouse gases become sources of oxygen required by burning in the gas burner, therefore, the carbon dioxide in greenhouse gases can be treated better, and the consumption of precious air in spaces can be reduced.

4. Because a recovery device is adopted in the invention, for industries, enterprises and units (such as power plants, canteens and chemical plants) which have severe contaminations and can not be renovated by lack of conditions or capitals, in the existing environment, once the recovery device is arranged in the industries, enterprises or units to recover greenhouse gases, and then the recovered greenhouse gases are conveyed to the inside of the gas burner to carry out burning treatment, the greenhouse gases can be treated quickly and converted into clean gases required by human beings or release gases with an oxygen content higher than the contents of other components, thereby thoroughly solving the existing serious pollution problems caused by greenhouse gases, and achieving an energy conservation and environment protection effect. In such a way, original seriously polluted industries, units and enterprises can be developed continuously and persistently.

5. Because the recovery device and the gas burner in the invention are combined simply and installed simply and conveniently, when in use, original facilities are not required to be replaced, so that the cost is low; and because the recovered greenhouse gases are used as burning improvers when in use, the process disclosed by the invention is not only environmental-friendly, but also more energy-saving, and experiments prove that at least more than 30% of gas can be saved.

6. Because the siphon preheating gas drum is adopted in the invention, the gas burner can carry out preheating on the gas and greenhouse gases of the burner in low-pressure gas supply environments, so that the defects that when the gas quantity demand is large, because the gas supply quantity falls behind, a firepower reduction situation is caused, and the treatment of greenhouse gases can not be performed, thereby causing the reduction of gas utilization rate, and the like are overcome, thereby achieving the effects of stronger firepower, more energy-saving, and capability of improving the gas utilization rate and effectually treating the emission of greenhouse gases.

7. Because the expander is adopted in the invention, when the gas burner is used, as a mixture of gas and other greenhouse gases passes through the expander, the volume is continually cracked and rapidly expanded, so that the gas can be fully burned, thereby greatly improving the utilization rate of gas and the emission treatment of greenhouse gases.

8. Because the furnace body is provided with a blocking plate with a round hole in the invention, gas after continually cracked and rapidly expanded in the furnace body through passing through the internal and external expanders is then further compressed, and when the gas is continually expanded and compressed, substances are concentrated into a small volume, and the temperature and density of the substances are increased to extreme points in the process of concentration, then molecular bond valences among the substances are subsequently cracked and a fusion phenomenon is caused, so that the high-speed rotation is caused, and a spiral black spot is formed because of the focusing in the center of the top end of the external expander, then a flame is released and burst out of the round hole on the blocking plate from the black spot in a tornado shape, and in the whole burning process, various substances in the gas, after subjected to a series of redox reactions, are converted into extremely high heat and then released, thereby achieving a perfect burning effect, so that the gas is burned more fully.

9. From the foregoing, the process disclosed by the invention has an immeasurable value, for example, through the implementation of the nationwide promotion and application of the process, a huge greenhouse gas effect faced by the earth currently and natural disasters caused by the greenhouse gas effect can be effectively controlled, so that an ideal natural balance state can be obtained rapidly.

### BRIEF DESCRIPTION OF THE DRAWINGS

FIG. 1 is the structure diagram of embodiment 1 of the invention

FIG. 2 is the sectional view along the line A-A of FIG. 1

FIG. 3 is the structure diagram of the gas burner of embodiment 1 of the invention

FIG. 4 is the structure diagram of another gas burner of embodiment 1 of the invention

FIG. 5 is the structure diagram of embodiment 2 of the invention

FIG. 6 is the structure diagram of embodiment 3 of the invention

FIG. 7 is the sectional view along the line B-B of FIG. 6

FIG. 8 is the burning effect diagram of the gas burner taking a greenhouse gas (containing water vapor) as a burning improver

### DETAILED DESCRIPTION OF THE INVENTION

### Embodiment 1

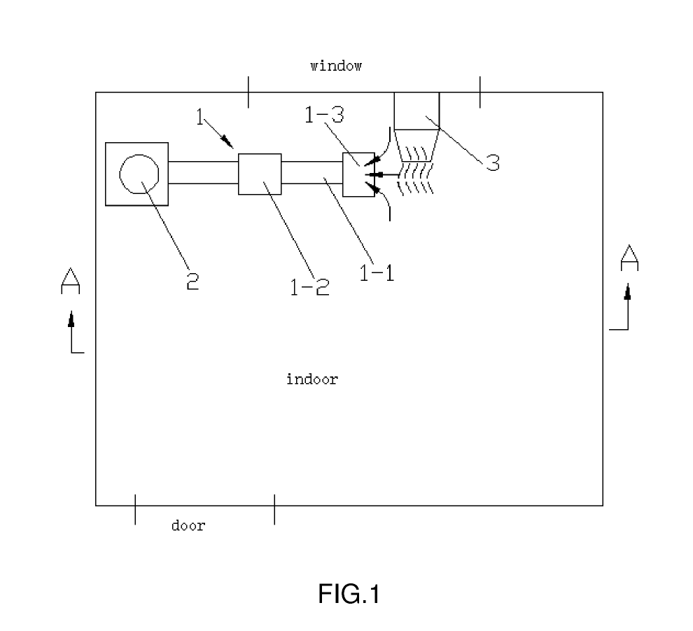

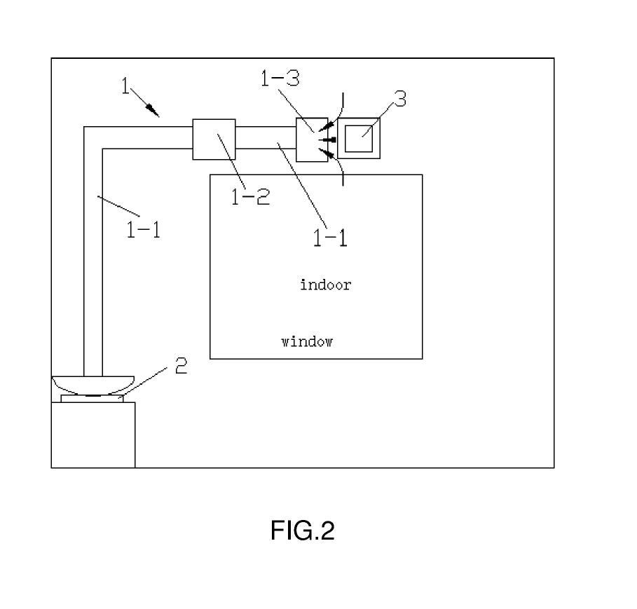

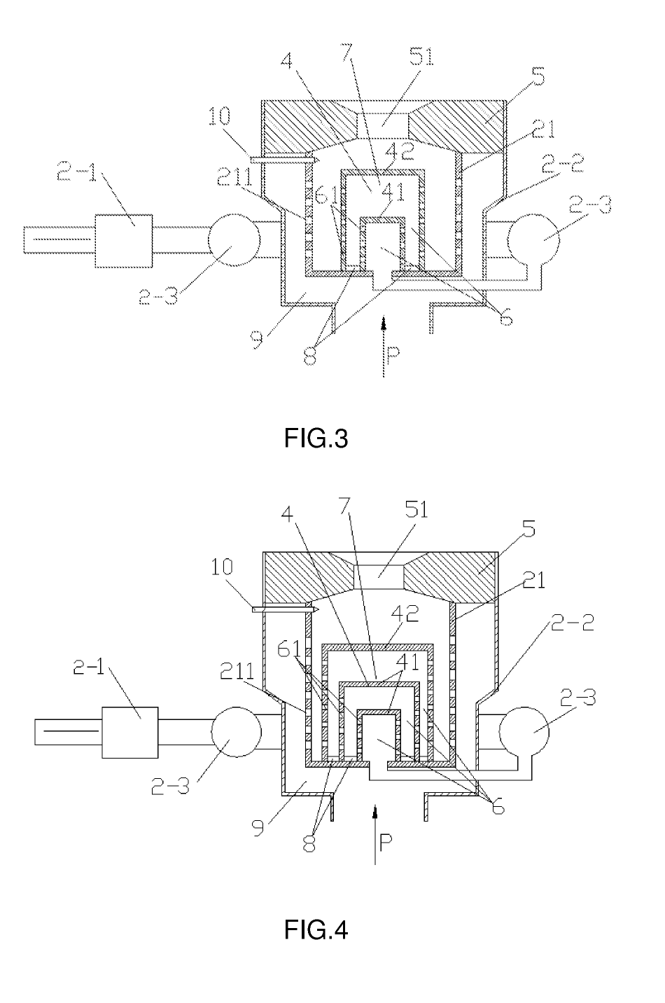

As shown in FIGS. 1-4, a greenhouse gas recovery device 1 is arranged at the upper part of an indoor space, the underside of the recovery device 1 is communicated to the inside of an air inlet P of a gas burner 2, the recovery device 1 mainly comprises a recovery tube 1-1 and an exhaust fan 1-2, the recovery tube 1-1 is distributed at the upper part of an indoor space, the recovery tube 1-1 is provided with an exhaust port 1-3, the recovery tube 1-1 is provided with an exhaust fan 1-2 for carrying out back-pumping on gas of the exhaust port, and the exhaust port 1-3 is provided with a water vapor feeder 3. The water vapor feeder 3 supplies appropriate water vapor to the gas burner 2, and the gas burner comprises a safety valve 2-1, a furnace body 2-2 and a siphon preheating gas drum 2-3, as shown in FIG. 3. An expander 4 is arranged in a hearth 21 of the furnace body 2-2, the expander 4 is divided into internal expander 41 and external expander 42, the internal and external expanders are respectively cylindrical with a cavity 6 (namely, the internal/external expanders are respectively a shelly cylinder), a plurality of through holes 61 are distributed on the side edge of each cavity, and an external expander 42 is sleeved on an internal expander 41, so that a compression chamber 7 is formed between thereof, a connecting component 8 is arranged between the internal expander 41 and the external expander 42, and the connecting component connects the internal expander 41 and the external expander together so as to facilitate the installation and application. The siphon preheating gas drum 2-3 is a pipeline which is annularly wound around the furnace body 2-2 and communicated to the inside of the expander 4 in the hearth 21, the pipeline is connected to a gas input port provided with the safety valve 2-1, the top of the furnace body 2-2 is provided with a blocking plate 5 with a round hole 51 at the central position thereof, and the size of the round hole 51 accounts for 1/10-½ of an opening of the hearth. A gas inlet channel 9 is arranged between the furnace body 2-2 and the hearth 21, the gas inlet channel is used as a channel for introducing natural gas into the hearth 21, a plurality of through holes 211 are distributed on the side wall of the hearth 21, the hearth 21 is provided with an electronic igniter 10, and the igniter is fixedly arranged on the furnace body 2-2 and the hearth 21.

The number of the internal expander 41 of the expander 4 of the gas burner is two or more, as shown in FIG. 4.

The water vapor feeder 1-3 also can be arranged on the gas burner 2 so as to directly convey water vapor to the inside of the gas burner.

The embodiment is further detailedly described according to the working principle as follows:

The exhaust fan 1-2 is started to pump indoor greenhouse gases (including water vapor emitted by the water vapor feeder 3) back to the inside of the gas burner 2 through the exhaust port 1-3 of the recovery tube 1-1, and then the indoor greenhouse gases are mixed with gas so as to form a gas mixture; after the electronic igniter 10 is started, the gas mixture burns so as to preheat the siphon preheating gas drum 2-3, and absorbed heat is conducted to the gas mixture in the gas drum, so that the gas mixture is expanded, and the pressure of the gas mixture rises; the gas mixture flows out of the siphon preheating gas drum and enters into the expander 4 through a pipeline, and the volume of the gas mixture is continually cracked and rapidly expanded in the inner cavities of the internal expanders 41 and the external expanders 42 of the expander 4 until the gas mixture reaches the hearth 21; and in the hearth, because the furnace body 2-2 is provided with a blocking plate 5 which is just provided with a round hole 51 at the central position thereof, the gas mixture can not flow out of the furnace body quickly and is blocked in the hearth 21, so that the gas mixture emits heat just after unceasingly compressed in the hearth 21.

Specifically, when the gas mixture (including gas, indoor greenhouse gases, water vapor emitted by the water vapor feeder 1-3) enters into the expander 4 in the burner, because the expander 4 is cylindrical with a cavity 6 (namely, the internal/external expanders are respectively a shelly cylinder), and a plurality of through holes 61 as vent holes are just distributed on the side edge of each cavity, when the gas mixture enters into the expander 4 in the burner, the gas mixture is completely blocked in the inner cavity of the expander 4 by the expander 4 and can not quickly flow into the hearth of the burner, so that molecules of the gas mixture only can be mutually extruded and collided in the expander 4 so as to cause the continual cracking of the molecules of the gas mixture. The expander 4 is divided into internal expander 41 and external expander 42, so that when the gas mixture passes through the internal/external expanders, the molecules of the gas mixture are subjected to multiple blocking, extrusion and mutual collision in a plurality of compression cavities 7 formed in the expander 4, and the more intense the collision and the cracking are, the higher the burning utilization rate of the gas mixture is. Therefore, a better effect is obtained once the internal expanders are distributed to multiple layers.

When the molecules of the gas mixture, after continually cracked in the expander 4, enters into the hearth 21 of the burner, natural gas introduced from a plurality of through holes 211 distributed on the side wall of the hearth 21 and the cracked molecules of the gas mixture in the hearth are mutually collided, and then ignited by the electronic igniter 10 in the hearth so as to produce temperature and fusion. In the fusion, because only the central position of the blocking plate 5 is provided with a round hole 51 as a fire outlet, and the size of the round hole 51 accounts for 1/10-½ of the opening of the hearth, the gas mixture can not quickly rush out of the fire outlet and still continually move in the hearth, in this process, the burner concentrates substances of the gas mixture into a small volume (namely, the volume of the continuously introduced gas is compressed into a small volume, and the density of the gas is increased), when the gas mixture is ignited, the temperature and density of the gas mixture are suddenly increased to extreme points in the concentrating process, as long as the molecular bond valences among the substances are subsequently cracked, then a fusion phenomenon is further generated, so that the high-speed rotation is caused, and a spiral black spot is formed because of the focusing in the center of the top end of the external expander, and a flame is released and burst out of the round hole 51 on the blocking plate 5 from the black spot in a tornado shape. Various substances in the gas mixture, after subjected to a series of redox reactions, are converted into extremely high heat and then released, thereby achieving a perfect burning effect, so that the gas mixture is burned more fully. In the process of energy release, the volume of compressed gas in a space is rapidly expanded, so that large amounts of heat are released in a burning mode, as shown in FIG. 8, taking a situation that a mixture of water vapor and carbon dioxide is used as a burning improver at a low-pressure gas consumption of 1.5 kg/h for example, the burning effect and discharged gas, the burning temperature at the position 10 cm away from the surface of the burner can reach more than 1100° C.; the burning temperature at the position 70 cm away from the surface of the burner can reach more than 122° C.; and the burning temperature at the position 130 cm away from the surface of the burner can reach more than 104° C. But the temperature inside the hearth is just below 200° C. Even if a gas igniter is already started, the gas mixture also can not be burned in the hearth.

The whole burning process of the gas mixture is mainly characterized in that: when the gas mixture (gas and greenhouse gases) enters into the gas burner 2, the gas mixture is subjected to continuous collision, extrusion and friction, but substances are subjected to mutual chemical combination and no flame is produced, so that a continuous expansion reaction is triggered in the expander 4, and a large thrust is produced, thereby causing the high-speed rotation of gas energy in the burner. As an astrophysical phenomenon, an accretion disk motion as one of conditions of forming a black-hole center jet phenomenon is moved to the center, and focused into a mass point, at this moment, an extremely high density field state is produced in the hearth 21, the heat and light generated by reaction are absorbed, so that no light is emitted from the inside of the hearth 21 until the load of the mass point is in a saturated state, various chemical compounds (such as carbon dioxide CO2, water vapor H2O, methane CH4, ethane C2H6, air, and the like) just brought to the mass point by an attractive force are bonded together by a large aggregation force, and an extremely high temperature and high pressure state assume internally in the mass point, the bonding of bond energy among different chemical compounds is defused, and the chemical compounds are in an unbound state, in such a way, the chemical compounds are decomposed into pure oxygen, hydrogen, nitrogen and carbon substances, and in the process of carrying out high pressure and high temperature burning on the pure substances, the atomic number structures of the pure substances are subjected to mutual reaction, and then the simplest atomic numbers are formed, and when the load of the mass point is in a saturated light and heat state, the simple atomic substances are released to the air with clean air, therefore, no substance polluting the air is produced.

From the foregoing, the oxidation reductions of gas in the air have a significant difference in the processes of gas burning between the gas burner in the invention and a common gas burner, and under the condition of same burning work, the energy consumption and the emission and measurement unit of greenhouse gases have significant differences, a larger produced exhausted gas quantity shows that the molecules of gas elements are released to the air with a lot of unreleased energy, conversely, a smaller exhausted gas quantity shows that the energy released by the molecules of gas elements is large. Specifically: the smaller the gas consumption is, the higher the released heat is, and the smaller the measurement-involved unit number of the component emission of greenhouse gases is; and the larger the gas consumption is, the smaller the released heat is, and the smaller the measurement-involved unit number of the component emission of greenhouse gases is.

### Embodiment 2

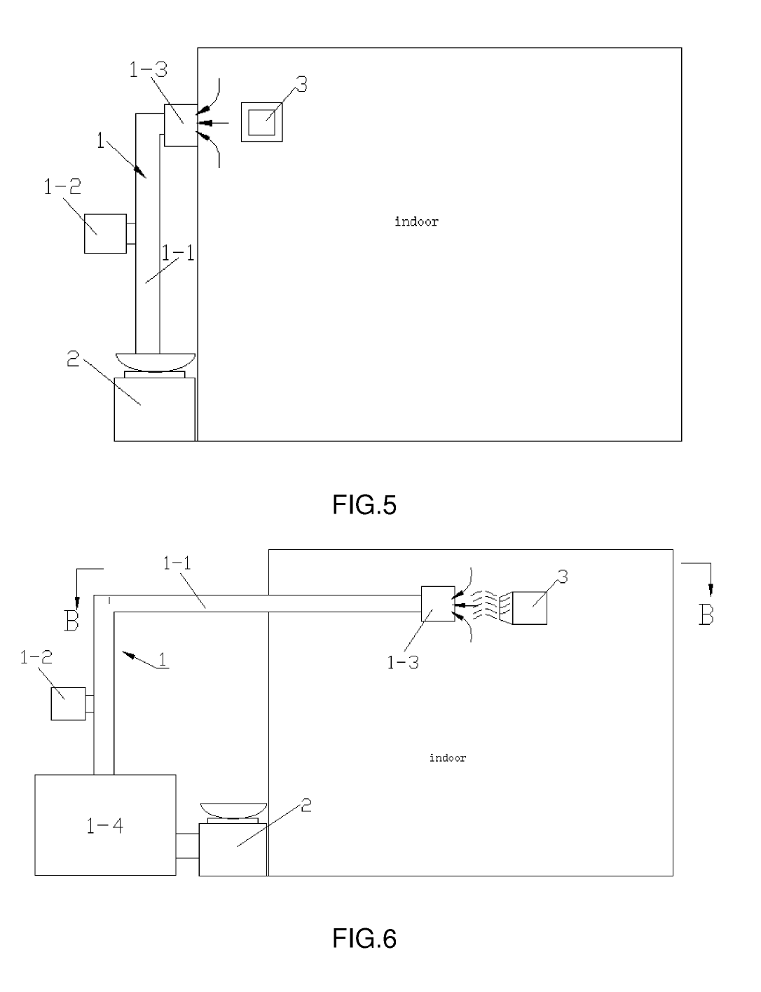

As shown in FIG. 5, the greenhouse gas recovery device 1 and the gas burner 2 in the invention are arranged outdoors, so that the indoor space can be saved, and the recovery tube 1-1 passes through the wall body to carry out recovery on indoor greenhouse gases. The rest is the same as the embodiment 1.

### Embodiment 3

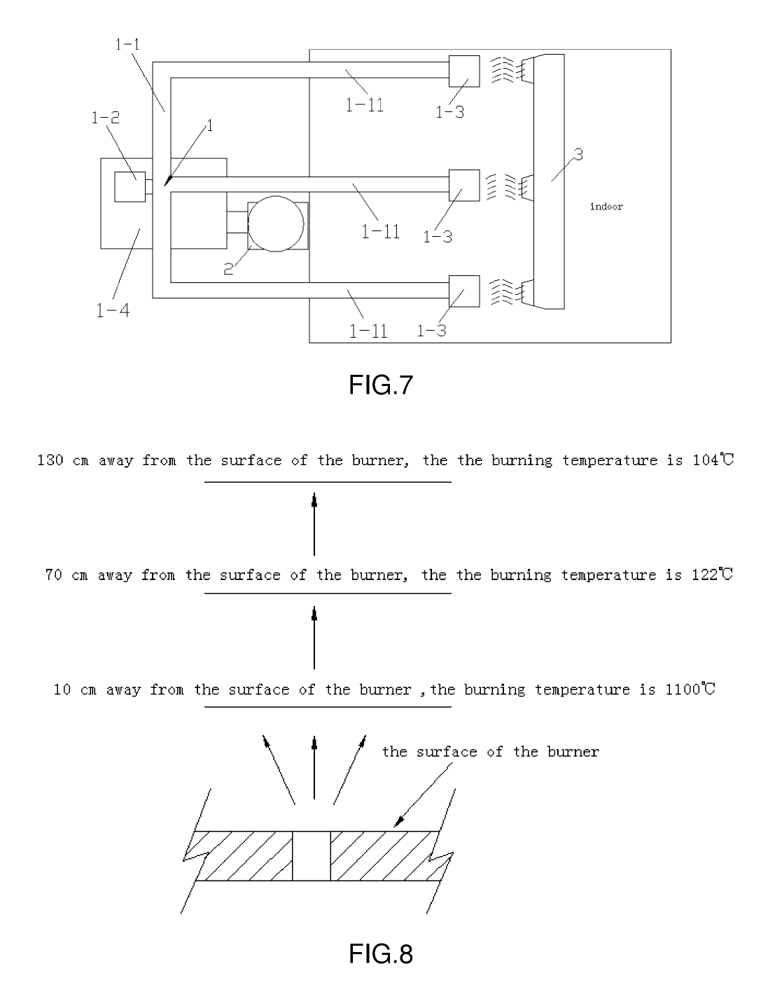

As shown in FIGS. 6 and 7, if the space is large, the recovery tube 1-1 can be branched into a plurality of branch tubes 1-11 which are averagely distributed in an indoor space, thereby more facilitating the recovery of greenhouse gases, providing the recovery tube 1-1 with a container 1-4, the greenhouse gases collected by the recovery device 1 can be temporarily stored in the container 1-4, and an outlet of the container 1-4 is connected to an air inlet P of the gas burner 2, so that greenhouse gases are conveyed to the inside of the gas burner 2 from the container 1-4, and then the greenhouse gases therein are subjected to burning treatment by using the gas burner 2. The rest is the same as the embodiment 1.

The process for treating a greenhouse gas in the embodiments above can be used according to special environments, 1, for example, in Chinese restaurants, a gas appliance in the kitchen can be replaced with the gas burner in the invention or the recovery device in the invention is simultaneously installed indoors, the recovery tube of the recovery device also can be connected to an exhaust delivery pipe of a commonly used smoke exhaust ventilator so as to carry out recovery on lampblack, in such a way, gas can be saved, and the generation of greenhouse gases is reduced, meanwhile, the thermal radiation generated by flames on the human body can be reduced, the physical and mental health can be affected, and fried dishes are more delicious; 2, for example, in chemical plants and power plants, the recovery device can be installed indoors or on the chimney outlets of power plants so as to carry out recovery treatment on greenhouse gases (such as carbon dioxide, sulfides, chlorine gas, water vapor, and the like) of the chemical plants and the power plants; and 3, if the process is used in vehicles and ships and the like, power systems on vehicles and ships can be improved according to the principle of the gas burner in the invention, so that the emission of greenhouse gases of vehicles and ships can be reduced.

For explaining the specific implementation effect of the process disclosed by the invention better, a specific detecting experiment is performed in the invention, and the detection details are as follows:

Detection Unit: Dacheng Environment Detection Co., Ltd in Dongguan, Guangdong, China

Detection Sampling Date: Sep. 6, 2010

Detection Completion Date: Sep. 9, 2010

Workplace Air

| | | | | | Occupational Exposure Limits For | | |
|---|---|---|---|---|---|---|---|
| | | | | | Hazardous Agents in the Workplace: | | |
| | | | | | Chemical Hazardous Agents GBZ 2.1-2007 | | |
| | | | | | | PC-TWA | PC-STEL |
| | | | | | MAC | (permissible | (permissible |
| | | | | | (maximum | concentration- | concentration- |
| Serial | Sampling | Supervision | | Detection | acceptable | time weighted | short term |
| Number | Point | Item | Unit | Result | concentration) | average) | exposure limit) |
| 1 | Above the flame | nitrogen dioxide | Mg/m3 | 0.124 | — | 5 | 10 |
| | opening of | carbon monoxide | Mg/m3 | 8.1 | — | 20 | 30 |
| | the gas burner | (non-highland) | | | | | |
| | (130 cm away | carbon dioxide | Mg/m3 | 2156 | — | 9000 | 18000 |
| | from the flame | total hydrocarbon | Mg/m3 | 3.38 | — | — | — |
| | opening) | methane | Mg/m3 | 1.71 | — | — | — |
| | | oxygen | % | 20.6 | — | — | — |
| | | concentration | | | | | |
| | | flame temperature | ° C. | 104 | — | — | — |
| | | pressure | pa | 8 | — | — | — |

Electric Field Intensity

| | | | | | Occupational Exposure Limits For |
|---|---|---|---|---|---|
| | | | | | Hazardous Agents in the Workplace: |
| | | | | | Physical Hazardous Agents |
| Serial | Detection | Detection | Reference Plane and | Detection | GBZ 2.2-2007 |
| Number | Position | Unit | the Height Thereof | Result | power frequency electric field (kv/m) |
| 1 | operation post of | V/m | 1.5 m away from the | 0.29 | 5 |
| | the gas burner | | ground | | |
| | (normal burning) | | | | |
| 2 | operation post of | V/m | 1.5 m away from the | 0.66 | 5 |
| | the gas burner (at | | ground | | |
| | the moment of | | | | |
| | startup ignition) | | | | |

Sampling Description

| | | | | Environmental |
|---|---|---|---|---|
| | | | | Conditions |
| | | | | of Sampling |
| Serial | Detection | Detection | Sample | and Other |
| Number | Item | Parameter | Status | Descriptions |
| 1 | workplace | nitrogen dioxide, | normal | weather situation: |
| | air | carbon monoxide, | | mostly cloudy |
| | | carbon dioxide, | | indoor air |
| | | total hydrocarbon, | | temperature: |
| | | methane, oxygen | | 35.8° C. |
| | | concentration, | | relative |
| | | flame temperature, | | humidity: 51% |
| | | pressure | | Atmospheric |
| 2 | electromag- | power frequency | / | pressure: |
| | netic | electric field | | 100.4 kpa |
| | radiation | | | wind speed: |
| | | | | 0.1-2.9 m/s |

Main Instruments and Equipment

| Serial | Names of Instruments | | |
|---|---|---|---|
| Number | and Equipment | Type | Manufacturer |
| 1 | ultraviolet and | UV-755B | Shanghai Analytical |
| | visible spectrophotometer | | Instrument |
| 2 | wind velocity indicator | Testo405-V1 | Testo |
| 3 | air sampler | QC-2B | Beijing Labor |
| | | | Protection |
| 4 | CO2 nondispersive infrared | GXH-3051 | Beijing Junfang |
| | gas analyser | | |
| 5 | CO infrared gas analyser | GXH-3051 | Beijing Junfang |
| 6 | pitot-tube parallel | WJ-60B | Qingdao Laoshan |
| | full-automatic smoke | | |
| | (lampblack) sampler | | |
| 7 | gas chromatograph | GC-9800 (N) | Shanghai Kechuang |
| 8 | hygrothermograph | CENTER | Taiwan 040501501 |
| 9 | aneroid barometer | YM3 | Shangqixiang |
| | | | Company |
| 10 | electric field tester | TES-92 | Taici Electronics |

Based Method Standards of the Detection

| Detection | | |
|---|---|---|
| Item | Parameter | Method Standards |
| workplace | nitrogen | Griess-Saltzman Method |
| air | dioxide | GBZ/t160.29-2004(3) |
| | carbon | Nondispersive Infrared |
| | monoxide | Gas Analyzer Method for Carbon |
| | carbon | Monoxide and Carbon Dioxide |
| | dioxide | GBZ/t160.28-2004(3) |
| | total | Thermal Desorption-Gas |
| | hydrocarbon | Chromatographic Method for Total |
| | methane | Non-Methane Hydrocarbon GBZ/ |
| | | t160.40-2004(4) |
| | flame | The Determination of Particulates |
| | temperature | and Sampling Methods of |
| | pressure | Gaseous Pollutants from Exhaust |
| | | Gas of Stationary Source |
| | | GB/T16157-1996 (reference) |
| | oxygen | Constant Potential Electrolysis |
| | concentration | Method(B) Analysis Method for |
| | | the Monitoring of Air and Exhaust |
| | | Gas (4th edition) (reference) |
| electromag- | power | Measurement of Physical Agents in |
| netic | frequency | Workplace: Power Frequency |
| radiation | electric field | Electric Field GBZ/T189.3-2007 |

Note:
1, Gas pressure: low pressure
2, water vapor is added at the exhaust port (3 L/h evaporation capacity).
3, doors and windows of an operating space with an area of about 10 m2 are completely opened.
4, an operation of measuring begins after the flame burns 15 minutes.
5, the oxygen concentration refers to a value measured when carbon dioxide is added into the exhaust port of the exhaust fan, and the volatilization amount of the carbon dioxide is 7 L/h

What is claimed is:

1. A process for treating a greenhouse gas, wherein a greenhouse gas is recovered to a gas burner (2) by using a recovery device (1) to carry out a treatment by burning.

2. The process for treating a greenhouse gas according to claim 1, wherein the recovery device (1) is a recovery tube (1-1) arranged at the upper part of an indoor space, the recovery tube (1-1) is at least equipped with an exhaust fan (1-2), and the recovery tube (1-1) is at least provided with an exhaust port (1-3).

3. The process for treating a greenhouse gas according to claim 1, wherein the gas burner (2) is provided with a water vapor feeder (3) for feeding water vapor into the gas burner.

4. The process for treating a greenhouse gas according to claim 2, wherein the exhaust port (1-3) is provided with a water vapor feeder (3).

5. The process for treating a greenhouse gas according to claim 2, wherein the recovery tube (1-1) is provided with a sealed container (1-4) for storing the greenhouse gas.

6. The process for treating a greenhouse gas according to claim 1, wherein the gas burner (2) comprises a safety valve (2-1), a furnace body (2-2) and a siphon preheating gas drum (2-3), an expander (4) is arranged in a hearth (21) of the furnace body (2-2), the siphon preheating gas drum (2-3) is a pipeline which is annularly wound around the furnace body (2-2) and communicated to the inside of the expander (4), and the furnace body (2-2) is provided with a blocking plate (5) with a round hole (51) at the central position thereof.

7. The process for treating a greenhouse gas according to claim 6, wherein the expander (4) is divided into internal expander (41) and external expander (42), the internal/external expanders are respectively cylindrical, square, polygonal or starlike with a cavity (6), a plurality of through holes (61) are distributed on the side edge of each cavity, and an external expander (42) is sleeved on an internal expander (41), so that a compression chamber (7) is formed between thereof.

8. The process for treating a greenhouse gas according to claim 6, wherein the number of the internal expander (41) or the external expander (42) is one or more than two, so that one or more compression chambers (7) are formed.

9. The process for treating a greenhouse gas according to claim 5, wherein a connecting component (8) is arranged between the internal expander (41) and the external expander (42).

10. The process for treating a greenhouse gas according to claim 6, wherein a gas inlet channel (9) is arranged between the furnace body (2-2) and the hearth (21), and a plurality of through holes (211) are distributed on the side wall of the hearth (21).
